(19) United States
(12) Patent Application Publication
(10) Pub. No.: US 2001/0009650 A1
(43) Pub. Date: Jul. 26, 2001

(54) Metallic carrier for catalytic converter

(76) Inventors: Hiroshi Kodama, Tokyo (JP); Tatsuo Sato, Kanagawa (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/768,512

(22) Filed: Jan. 25, 2001

(30) Foreign Application Priority Data
Jan. 26, 2000 (JP) P. 2000-017165

(51) Int. Cl. B01D 53/34

(52) U.S. Cl. 422/177; 422/168; 422/180; 422/181

(57) ABSTRACT

A metallic carrier for a catalytic converter in which a brazing foil material 7 is wound around an outer periphery of an exhaust gas outlet side of a core 5 formed by superposing one on top another a corrugated sheet 1 and a flat sheet 3 formed of a metal sheet and by rolling them, and an assembly thereof is press-fitted into a metallic outer cylinder 15 and is subjected to heat treatment so as to diffusionally join together the corrugated sheet 1 and the flat sheet 3 and join together an inner periphery of the outer cylinder 15 and an outer periphery of the core 5 by a brazing material 7-1, is characterized in that a solder-rising preventing groove 19 is provided over an entire circumference of the inner periphery of the outer cylinder 15 at a position located on an exhaust gas inlet side of an area for joining the core 5.

### BACKGROUND OF THE INVENTION

1. Field of the Invention

The present invention relates to a metallic carrier for a catalytic converter which is installed in an exhaust system of an internal combustion engine or the like.

2. Description of the Related Art

Conventionally, a catalytic converter for purifying exhaust gases is installed in an exhaust system of an internal combustion engine. As a catalytic carrier used therefor, a metallic carrier formed of metal sheets such as Fe—Cr—Al base ferritic stainless foils (20Cr—5Al—La—Fe) or the like is widely used.

A method of manufacturing the metallic carrier is shown in JP-A-5-131143 or FIGS. 4 to 7. A manufacturing method is known in which a belt-shaped corrugated sheet 1 and a flat sheet 3 which are formed of metal sheets are alternately superposed one on another, and are rolled and formed into a core (honeycomb body) 5 having a circular cross-sectional shape or a cross-sectional shape of a racing track, and an Ni brazing foil material 7 is wound around an outer periphery of the rear side (exhaust gas outlet side) of the core 5 or a central portion thereof. This assembly is press-fitted in a metallic outer cylinder 9 and is heated (subjected to heat treatment) in a vacuum state so as to diffionally join together the corrugated sheet 1 and the flat sheet 3 and braze together the outer cylinder 9 and the core 5, thereby manufacturing the metallic carrier 11 or 13.

The aforementioned shape of a racing track refers to a substantially elliptical shape similar to the shape of a track in track and field and consisting of two opposing straight portions and two opposing semicircular portions connecting them.

With the above-described conventional manufacturing method, however, there have been cases where, as shown in FIG. 8, a brazing material 7-1 which melted during heat treatment rises to the front side (exhaust gas inlet side) of the core 5 due to the capillary phenomenon to cause the front side of the core 5 to be partially bonded to the outer cylinder 9, or as shown in FIG. 9, the molten brazing material 7-1 flows out to the front side or the rear side of the core 5 to cause the front side or the rear side of the core 5 to be partially joined to the outer cylinder 9.

However, since there is a difference in thermal expansion between the core 5 and outer cylinder 9, there has been a possibility that if the core 5 is partially joined to the outer cylinder 9, the portion of the core 5 which is joined to the outer cylinder 9 can break without being able to follow its own thermal shrinkage, or parts of the core 5 can fall away in cellular forms, coupled with the fact that the concentration of stress occurs in the joined portions of the core 5 and the outer cylinder 9.

### SUMMARY OF THE INVENTION

The invention has been devised in view of the above-described circumstances, and its object is to provide a metallic carrier for a catalytic converter which is aimed at preventing falling away of core parts in cellular forms due to the rising of the solder during heat treatment.

To attain the above object, according to the invention, there is provided a metallic carrier for a catalytic converter in which a brazing foil material is wound around an outer periphery of an exhaust gas outlet side of a core formed by superposing one on top another corrugated sheet and flat sheet formed of metal sheets and by rolling them, and an assembly thereof is press-fitted into a metallic outer cylinder and is subjected to heat treatment so as to diffusionally join together the corrugated sheet and the flat sheet and join together an inner periphery of the outer cylinder and an outer periphery of the core by a brazing material, characterized in that a solder-rising preventing groove is provided over an entire circumference of the inner periphery of the outer cylinder at a position located on an exhaust gas inlet side of an area for joining the core).

In addition, according to the invention, there is provided a metallic carrier for a catalytic converter in which a brazing foil material is wound around an outer periphery of a central portion of a core formed by superposing one on top another corrugated sheet and flat sheet formed of a metal sheet and by rolling them, and an assembly there of is press-fitted into a metallic outer cylinder and is subjected to heat treatment so as to diffusionally join together the corrugated sheet and the flat sheet and join together an inner periphery of the outer cylinder and an outer periphery of the core by a brazing material), characterized in that solder-rising preventing grooves are provided over an entire circumference of the inner periphery of the outer cylinder at positions located on an exhaust gas inlet side and an exhaust gas outlet side, respectively, of an area for joining the core.

In the invention, the brazing material which melted by heat treatment during its manufacture tends to rise toward the exhaust gas inlet side of the core due to the capillary phenomenon, but the brazing material holds in the solder-rising preventing groove provided in the inner periphery of the outer cylinder, thereby preventing the rising of the solder to the exhaust gas inlet side of the core.

In the invention, the brazing foil material melts and tends to flow toward the exhaust gas inlet side and the exhaust gas outlet side of the core due to the capillary phenomenon during heat treatment in its manufacturing process, but the brazing material holds in the solder-rising preventing grooves provided in the inner periphery of the outer cylinder, thereby preventing further efflux thereof, that is, preventing the melted brazing material from rising across the solder-rising preventing groove.

### BRIEF DESCRIPTION OF THE DRAWINGS

FIGS. 1A is a perspective view of an outer cylinder of a metallic carrier according to an embodiment of the invention.

FIGS. 1B is an enlarged sectional view of FIGS. 1A.

FIG. 2 is a perspective view of the metallic carrier according to the embodiment of the invention.

FIG. 3 is a perspective view of the metallic carrier according to another emboediment of the invention.

FIG. 4 is a perspective view of the outer cylinder and a core of a conventional metallic carrier.

FIG. 5 is a perspective view of the conventional metallic carrier.

FIG. 6 is a perspective view of the outer cylinder and the core of another conventional metallic carrier.

FIG. 7 is a perspective view of the other conventional metallic carrier.

FIG. 8 is an explanatory diagram illustrating the rising of a brazing material during the heat treatment of the metallic carrier shown in FIG. 5.

FIG. 9 is an explanatory diagram illustrating the rising of the brazing material during the heat treatment of the metallic carrier shown in FIG. 7.

FIG. 10 is a perspective view of the exhaust gas inlet side of the core in which falling away of core parts in cellular forms has occurred.

### DETAILED DESCRIPTION OF THE PRESENT INVENTION

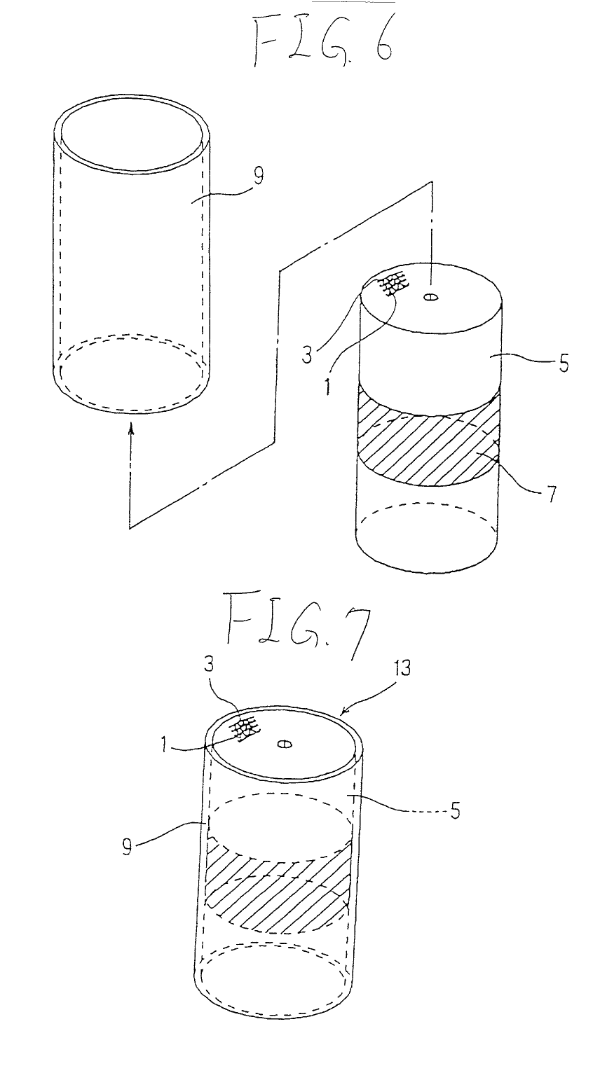

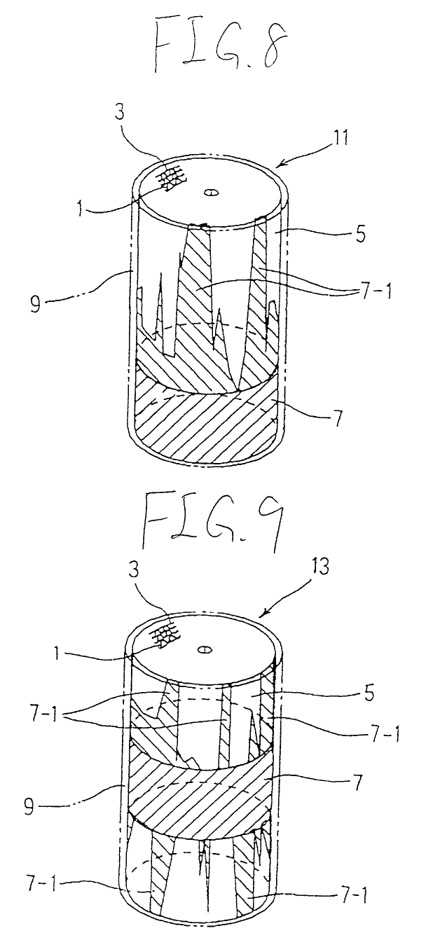

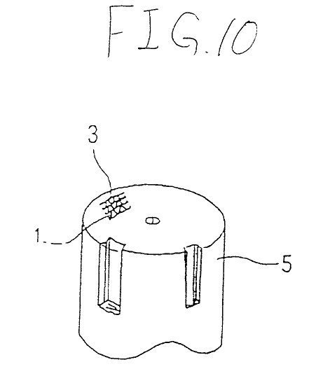

Referring now to the drawings, a description will be given of an embodiment of the invention. It should be noted that those parts or portions which are identical to those of the conventional examples shown in FIG. 4 and the drawings that follow are denoted by the same reference numerals.

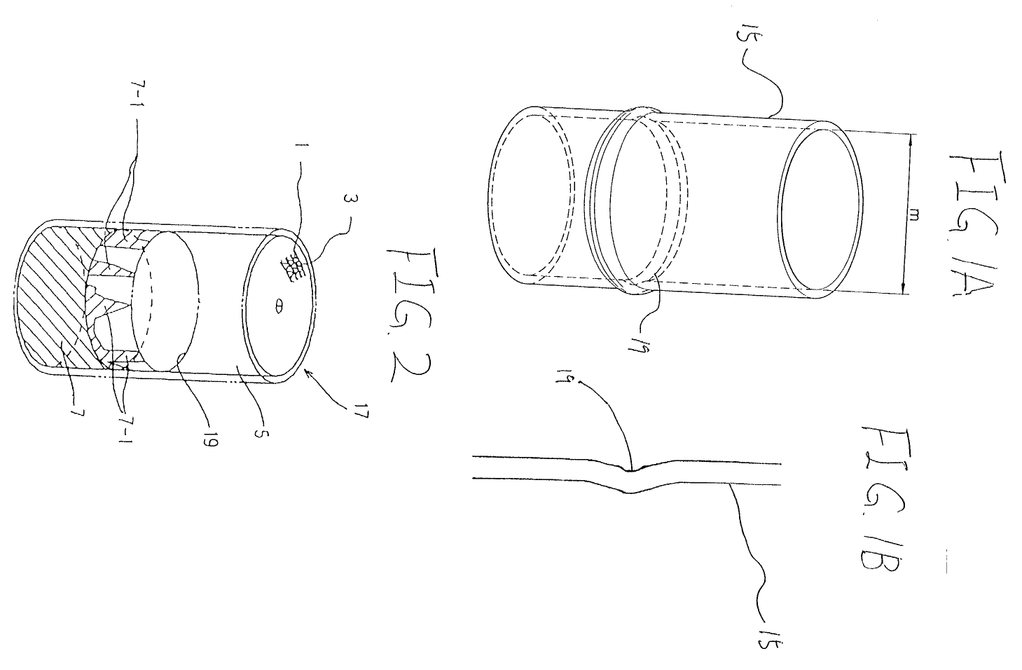

FIGS. 1A, 1B and 2 illustrate an embodiment of a metallic carrier of the invention. In the drawings, reference numeral 15 denotes a cylindrically shaped outer cylinder formed of a ferritic stainless steel of SUS 430, and the inside diameter m of the outer cylinder 15 is made smaller than the outside diameter n of a core 5 in FIG. 4 which is press-fitted into it.

In the same way as the metallic carrier 11 shown in FIG. 5, a metallic carrier 17 in accordance with the embodiment is manufactured such that after the core 5 with a brazing foil material 7 wound around an outer periphery of its rear side is press-fitted into the outer cylinder 15, this assembly is heated in a vacuum state to diffusionally join together a corrugated sheet 1 and a flat sheet 3 and join together the inner periphery of the outer cylinder 15 and the outer periphery of the core 5 by the brazing material. However, as shown in the drawings, the embodiment is characterized in that a solder-rising preventing groove 19 is provided over the entire circumference of the inner periphery of the outer cylinder 15 at a position located on the front side of the area for joining the core 5.

It should be noted that the width and the depth of the solder-rising preventing groove 19 are appropriately selected in accordance with the volume of the metallic carrier to be manufactured and the volume of the brazing foil material to be used.

Since the metallic carrier 17 in accordance with this embodiment is constructed as described above, as shown in FIG. 2, a brazing material 7-1 which melted by heat treatment during its manufacture tends to rise toward the front side of the core 5 due to the capillary phenomenon, but the brazing material 7-1 holds in the solder-rising preventing groove 19 provided in the inner periphery of the outer cylinder 15, thereby preventing the rising of the solder to the front side of the core 5.

Accordingly, in accordance with the embodiment, the partial joining of the outer cylinder 15 and the front side of the core 5 is prevented, with the result that falling away of core parts in cellular forms can be prevented.

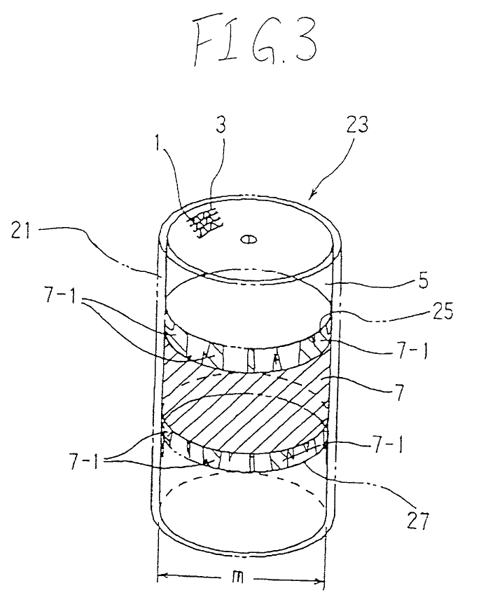

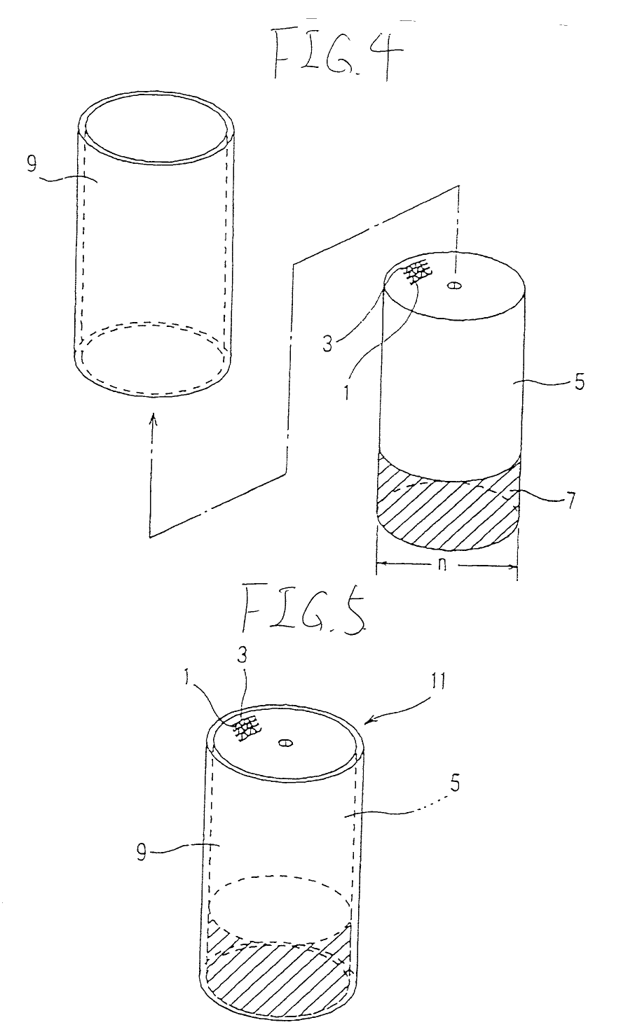

FIG. 3 illustrates another embodiment of the metallic carrier in accordance with claim 2. In the drawing, reference numeral 21 denotes an outer cylinder formed of the same material as the aforementioned outer cylinder 15, and the inside diameter m of the outer cylinder 21 is also made smaller than the outside diameter n of the core 5 which is press-fitted into it.

In the same way as the metallic carrier 13 shown in FIG. 7, a metallic carrier 23 in accordance with this embodiment is manufactured such that after the core 5 with the brazing foil material 7 wound around an outer periphery of its central portion is press-fitted into the outer cylinder 21, this assembly is heated in a vacuum state so as to diffusionally join together the corrugated sheet 1 and the flat sheet 3 and join together the inner periphery of the outer cylinder 21 and the outer periphery of the core 5 by the brazing material. However, this embodiment is characterized in that solder-rising preventing grooves 25 and 27 are provided over the entire circumference of the inner periphery of the outer cylinder 21 at positions located on the front side and the rear side, respectively, of the area for joining the core 5. The width and the depth of the solder-rising preventing groove 25 and 27 are appropriately selected in accordance with the volume of the metallic carrier to be manufactured and the volume of the brazing foil material to be used.

Since the metallic carrier 23 in accordance with the embodiment is constructed as described above, as shown in FIG. 3, the brazing foil material 7-1 melts and tends to flow toward the front side and the rear side of the core 5 due to the capillary phenomenon during heat treatment in its manufacturing process, but the brazing material 7-1 holds in the solder-rising preventing grooves 25 and 27 provided in the inner periphery of the outer cylinder 21, thereby preventing further efflux thereof.

Accordingly, in accordance with the embodiment, the partial joining of the outer cylinder 21 and the front and rear sides of the core 5 is prevented, with the result that it becomes possible to prevent falling away of core parts in cellular forms.

It should be noted that although, in the foregoing embodiments, the recessed solder-rising preventing grooves 19, 25, and 27 are provided in the inner periphery of the outer cylinder 15 or 21 to prevent the rising of the brazing material 7-1, an arrangement may be alternatively provided such that after the core with the brazing foil material wound around the outer periphery of its rear side is press-fitted into the outer cylinder, a portion of the outer cylinder located on the front side of the area for joining the core is made to protrude inwardly over the entire circumference, and an outermost layer of the core is crushed, thereby preventing the rising of the brazing material during heat treatment.

In addition, although in the above-described embodiments flat belt-shaped metal sheets are used as the flat sheet 3 for forming the core 5, the flat sheet having corrugations whose ridge height is sufficiently smaller than that of the corrugated sheet 1 may be used as the flat sheet 3.

As described above, in accordance with the metallic carrier according to the invention, the brazing material which melted by heat treatment during manufacture tends to rise toward the exhaust gas inlet side of the core due to the capillary phenomenon, but the brazing material holds in the solder-rising preventing groove provided in the inner periphery of the outer cylinder, thereby preventing the rising of the solder. Accordingly, the partial joining of the outer cylinder and the exhaust gas inlet side of the core is prevented, with the result that falling away of core parts in cellular forms can be prevented.

In addition, in accordance with the metallic carrier according to the invention, the brazing material which melted by heat treatment during manufacture tends to flow toward the exhaust gas inlet side and the exhaust gas outlet side of the core, but the brazing material holds in the solder-rising preventing groove provided in the inner periphery of the outer cylinder, thereby preventing further efflux thereof. Accordingly, it becomes possible to prevent falling away of core parts in cellular forms.

What is claimed is:

1. A metallic carrier for a catalytic converter comprising:
a corrugated sheet made of metal;
a flat sheet made of metal;
a core formed by superposing the corrugated sheet and flat sheet one on another and by rolling the corrugated sheet and the flat sheet in multiple times;
a brazing foil material wound around an outer periphery of an exaust gas outlet side of the core; and
a metalic outer cylinder into which an assembly including the core and the brazing foil material is press-fitted, the metalic outer cylinder subjected to heat treatment to diffusionally join the corrugated sheet and flat sheet, and join an inner periphery of the metalic outer cylinder and an outer periphery of the core by a brazing material,
wherein a solder-rising preventing groove is defined over an entire circumference of the inner periphery of the outer cylinder at a position located on an exhaust gas inlet side of an area for joining the core.

2. The metallic carrier as claimed in claim 1, wherein another solder-rising preventing groove is defined over an en tire circumference of the inner periphery of the outer cylinder at a position located on the exhaust gas outlet side of the area for joining the core.

3. A metallic carrier for a catalytic converter comprising:
a metalic outer cylinder defining a groove on an inner surface of the metalic outer cylinder;
a corrugated sheet made of metal;
a flat sheet made of metal;
a core including the corrugated sheet and the flat sheet superposed one on another and rolled in multiple times; and
a brazing material filled in the groove of the metalic outer cylinder, the brazing material joining the core to the metalic outer cylinder at the groove.

4. The metallic carrier as claimed in claim 3, wherein the flat sheet is diffusionally joined with the corrugated sheet.

5. The metallic carrier as claimed in claim 3, wherein the groove is defined over an entire circumference of the inner periphery of the outer cylinder at a position located on an exhaust gas inlet side of an area for joining the core.

6. The metallic carrier as claimed in claim 3, wherein the metallic outer cylinder defines a plurality of grooves on the inner surface thereof.

7. The metallic carrier as claimed in claim 3, wherein an edge of the core is above the groove.
